(19) United States
(12) Patent Application Publication
(10) Pub. No.: US 2016/0063061 A1
(43) Pub. Date: Mar. 3, 2016

(54) RANKING DOCUMENTS WITH TOPICS WITHIN GRAPH

(71) Applicant: Microsoft Corporation, Redmond, WA (US)

(72) Inventors: Dmitriy Meyerzon, Bellevue, WA (US); Nikita Voronkov, Bothell, WA (US); Yauhen Shnitko, Redmond, WA (US); Aninda Ray, Bellevue, WA (US); Sebastian Blohm, Cambridge (GB); Torbjorn Helvik, Tromso (NO)

(21) Appl. No.: 14/475,491

(22) Filed: Sep. 2, 2014

(51) Int. Cl. G06F 17/30

(52) U.S. Cl. CPC G06F 17/30477; G06F 17/30958; G06F 17/3053; G06F 17/30011

(57) ABSTRACT

Documents are ranked with topics within a graph. A user, a tag, and a document are placed as nodes in a graph. One or more relationships are established between the user, the tag, and the document. The nodes are connected with edges acting as the one or more relationships. The tag is promoted into a topic based on the one or more relationships.

### BACKGROUND

Search engines discover and store information about documents such as web pages, documents of different formats, etc., which they typically retrieve from the textual content of the documents. The documents are sometimes retrieved by a crawler or an automated browser, which may follow links in a document or on a website. Conventional crawlers typically analyze documents as flat text files to examine words and words' positions (e.g. titles, headings, or special fields), as well as link structure of the web, such as anchor text, page rank, clicks, and to build inverted indexes that are optimized for queries. The inverted indexes are challenging to update. Data about analyzed documents may be stored in an index database for use in later search queries. A query may include a single word or a combination of words, a combination of words and (or) metadata. In some cases, there may not be any query at all, and the crawler may return top documents relevant to the user for any query, or try to predict a set of documents that the user is more likely going to be interacting with at a particular moment in time. Returning a set of documents without any user query is called proactive search. When user has to type keywords, it's called reactive search.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to ranking documents with topics within a graph. In some example embodiments, a document management application may place a user, a tag, and a document as nodes in a graph. One or more relationships may be established between the user, the tag, and the document. The nodes may be connected with edges that act as the one or more relationships. The tag may be promoted into a topic based on the one or more relationships.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating components of a scheme to rank documents with topics within a graph, according to embodiments;

FIG. 2 illustrates an example of ranking documents with topics within a graph, according to embodiments;

FIG. 3 illustrates a detailed view of ranking documents with topics within a graph, according to embodiments;

FIG. 4 illustrates another detailed view of ranking documents with topics within a graph, according to embodiments;

FIG. 5 is a simplified networked environment, where a system according to embodiments may be implemented;

FIG. 6 illustrates a general purpose computing device, which may be configured to rank documents with topics within a graph; and

FIG. 7 illustrates a logic flow diagram for a process to rank documents with topics within a graph, according to embodiments.

### DETAILED DESCRIPTION

As briefly described above, documents may be ranked with topics within a graph by a document management application. A user, a tag, and a document may be placed as nodes in a graph. One or more relationships between the user, the tag, and the document may be established. The nodes may be connected with edges acting as one or more relationships. The tag may be promoted into a topic based on the one or more relationships.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to rank documents with topics within a graph. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

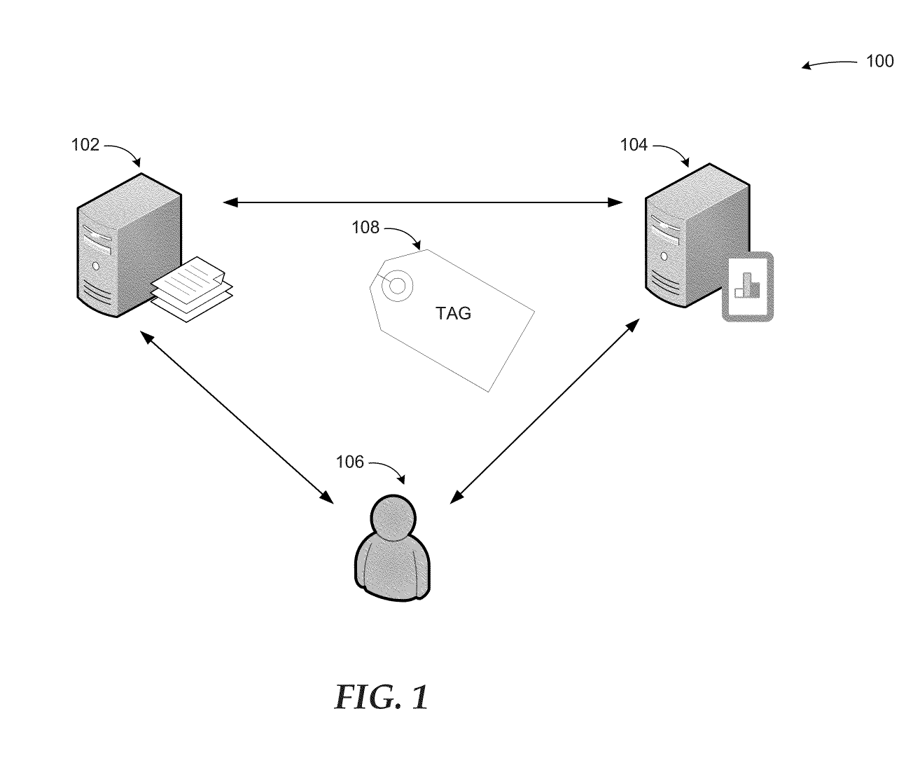

FIG. 1 is a conceptual diagram illustrating components of a scheme to rank documents with topics within a graph, according to embodiments.

In a diagram 100, a document management application may establish relationships between a document, a user 106, and a tag 108. An operation server 104 may execute the document management application. The document management application may be a stand-alone application or a distributed application that provides annotation functions associated with documents, users, tags, and similar entities. The annotation functions may include tagging operations of documents and users, among others. The operation server 104 may include one or more computing devices. An example of the document management application may be a cloud based service that executes on one or more servers such as the operation server 104 connected through a network with wired and/or wireless components.

The document management application may access one or more documents on a document server 102. The document server 102 may be a data store that provides access to the documents. The document server 102 may be located locally in relation to the operation server 104 which may include the document server 102 situated within a network shared with the operation server 104. Alternatively, the document server 102 may be located remotely in relation to the operation server 104 which may include the document server 102 situated outside a network associated with the operation server 104. The documents may also be stored within a computing device shared with the document management application such as the operation server 104.

The user 106 may interact with the document management application to annotate documents that may be stored by the document server 102. The user may include a person, a computing device, an application, a service, multitude of each, combination of each, among other entities. The user may provide a tag 108 to annotate a document. The tag 108 may include an identifier for the document. An example of a tag may include a title, a categorization, a type, a label, an identification, a related document, a name of a project, a name of a team/organization, a general topic, among others. The document management application may establish relationships between the user 106, the document, and the tag 108 in a graph. The graph may include a data structure that includes nodes that are connected with edges. A graph is a formal representation of a data structure consisting of nodes connected by edges. The graph may store the user 106, the tag 108, and the document as nodes. Relationships between the user 106, the tag 108, and the document may be established with edges that connect the user 106, the tag 108, and the document.

While the example system in FIG. 1 has been described with specific components including the operation server 104, the document server 102, the tag 108, embodiments are not limited to these components or system configurations and can be implemented with other system configuration employing fewer or additional components.

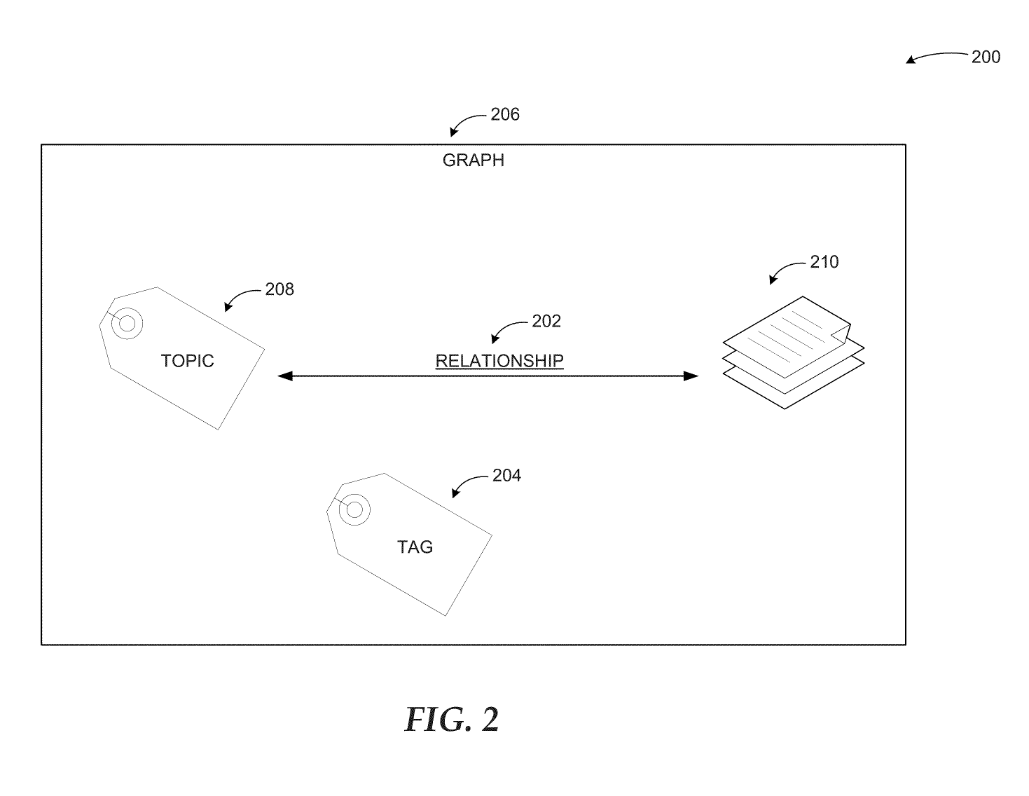

FIG. 2 illustrates an example of ranking documents with topics within a graph, according to embodiments.

In a diagram 200, a tag may be used to annotate a document 210. The document 210 may be a content document that stores content for consumption. The tag may provide an identifier associated with the document 210. An example may include a title, search terms, a description, a creation timestamp, a last modified timestamp, a general topic, a categorization, among others. Associating the tag with the document 210 may establish a relationship 202. The tag may be identified with unique identifier in a format such as a uniform resource located (URL) to apply to the document 210. The tag with a relationship 202 with another entity such as the document 210 may be promoted to a topic 208.

The relationship 202 may be defined by an edge in a graph 206 where the topic 208 and the document 210 and a tag 204 are nodes. The difference between the topic 208 and the tag 204 may be that the tag 204 is without a relationship and as such is not connected to an associated entity (i.e.: the document 210) with an edge. The nodes of the topic 208 and document 210 may be connected with an edge to establish the relationship between the nodes. An example edge may include a “taggedwith” edge that describes the document 210 tagged with the topic 208. Another example edge may include a “tagged” edge that describes the topic 208 that is used to tag the document 210.

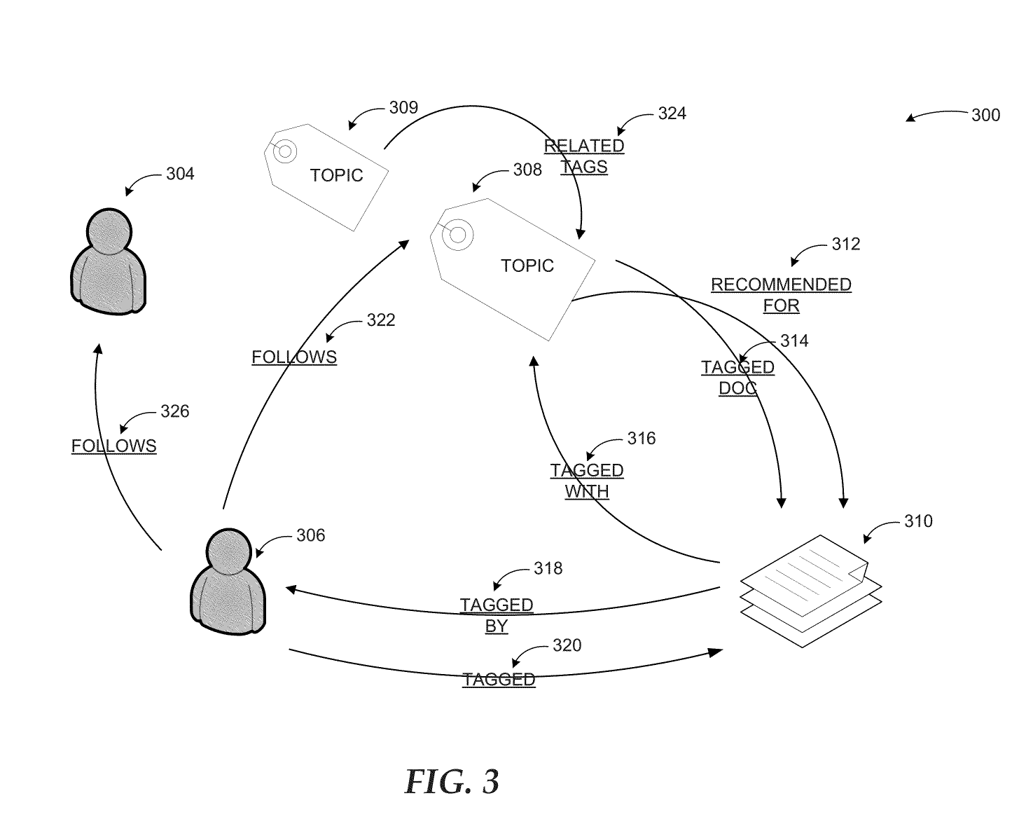

FIG. 3 illustrates a detailed view of ranking documents with topics within a graph, according to embodiments.

In a diagram 300, a document management application may establish relationships between a topic 308, a document 310, a user 306, and a circle 304 in a graph. The topic 308 may be a tag with a relationship with another entity. The topic 308 may also represent a relationship between other entities such as a relationship between the user 306 and the circle 304. The circle 304 may include other users followed by the user 306. The circle 304 may include other users that the user 306 may communicate through an email, a text message, a phone call and other communication modes.

The topic 308, the document 310, the user 306, and the circle 304 may be managed as nodes in the graph based on relationships with each other. The relationships may be described in edges of the graph where the topic 308, the document 310, the user 306 and the circle 304 may be nodes. The edges may connect the nodes which may establish the relationships.

Relationships between the topic 308 and a document 310 may be established within the graph using a “taggedwith” edge 316 and a “taggeddoc” edge 314. The “taggedwith” edge 316 may describe a relationship between the document 310 that is tagged with the topic 308. An example may include the document 310 that has a relationship of the “taggedwith” edge 316 with the topic 308 that may provide a category for the document 310 such as a work document, a school document, a personal document, among others. The “taggeddoc” edge 314 may describe the topic 308 used to tag the document 310. An example may include the document 310 that has a relationship of the “taggeddoc” edge 314 with the topic 308 that may include a label topic such as a title, an author, among others. A “recommendedfor” edge 312 may describe a relationship between the topic 308 and the document 310 to be included in the topic 308. The relationship established between the topic 308 and the document 310 also known as a “recommendation” may help the user 306 to create the “taggedwith” edge 316 and the “taggeddoc” edge 314.

A “tagged” edge 320 may describe a relationship between the document and the user 306 who tagged the document 310. A “taggedby” edge 318 may describe a relationship between the user 306 and the document 310 tagged by the user 306. A “follows” edge 326 may describe a relationship between the circle 304 and the user 306 who follows the circle 304. A “follows” edge 322 may describe a relationship between the topic 308 and the user 306 who follows the topic 308. A “relatedtags” edge 324 may describe a relationship between the topic 309 and other topics (e.g., topic 308) that are related because of a common attribute such as the user 306 who has related topics such as the topic 308. The “relatedtags” edge 324 may describe most relevant topics for a user based on a combination of factors that include a recentness and a volume of user interactions with the topic 308.

A list of documents may be retrieved from the graph in response to a query to retrieve documents associated with a topic. The documents related to the topic with a “taggeddoc” edge may be retrieved and provided as a result of the query. One or more “taggeddoc” edges may also be intersected with “tagged” edges to promote documents that had the topic 308 applied by the user 306.

The user 306 may also be allowed to apply topics on documents with tag completions and immediate suggestions Immediate suggestions may be generated by the document management application without an input from the user 306. The document management application may provide the immediate suggestions to apply topics to documents based on attributes. The attributes may include topics that were applied during a current document browsing session, recently applied topics, topics applied by the circle 304, popular topics associated with the user 306 and other entities, tags that may be extracted a content of the document 310, among others. Tags may be extracted from the content of the document 310 by parsing the content to detect one or more labels associated with the content such as a title of the document, a category associated with the document, among others

Tag completions may be provided by matching a query input by the user 306 against names of existing tags. The matched tags may be ordered based on number of matched terms and attributes used in immediate suggestion based topic applications to the documents.

The user 306, the circle 304, or an external entity with privileges may be allowed to provide a query to the document management application. The document management application may retrieve an entity from the graph using the query. The document management application may identify the entity in the query such as the user 306, the topic 308, the circle 304, and the document 310. Other entities associated with the entity in the query may be retrieved based on relationships represented by the edges. The entity and the other entities may be provided as results for the query.

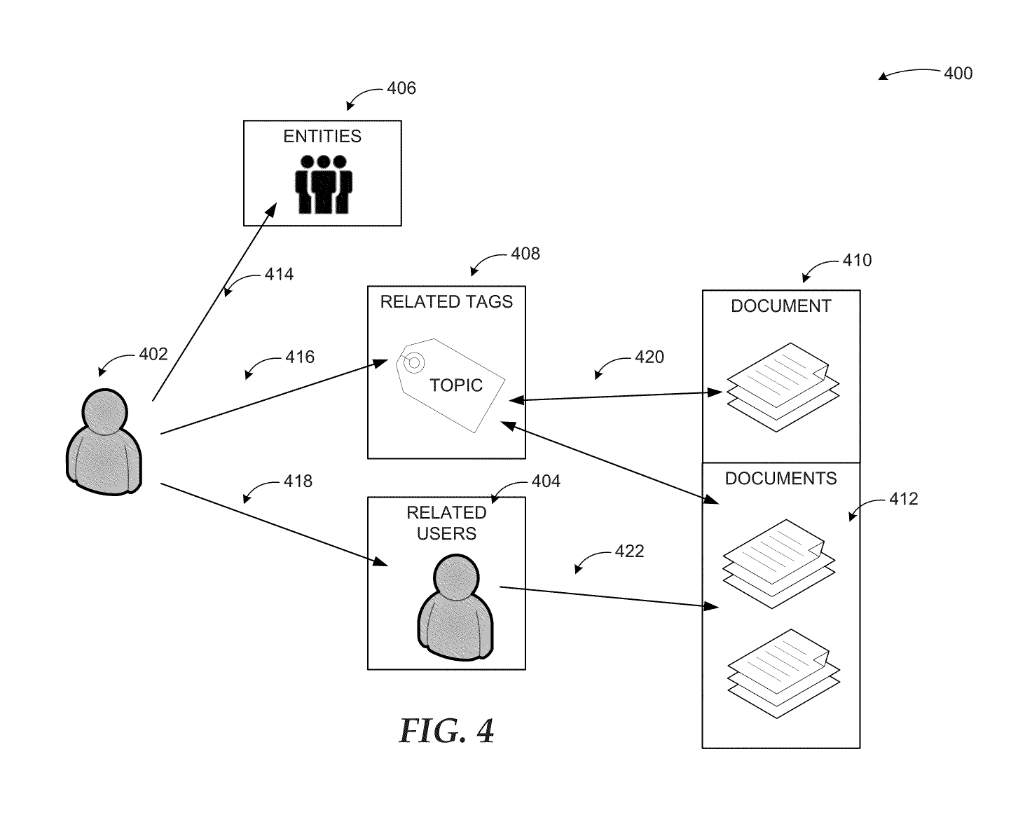

FIG. 4 illustrates another detailed view of ranking documents with topics within a graph, according to embodiments.

In a diagram 400, a document management application may establish relationships between a user 402, related users 404, related tags 408, entities 406, a document 410, and documents 412 which may be nodes in a graph. The nodes may be connected with edges which describe relationships between the nodes. The user 402 may be connected to the entities 406 with a “follows” edge 414 that describes the user who follows one or more actions of the entities 406. The “follows” edge 414 may also correspond to an action of the user 402. The “follows” edge 414 may express an interest of the user 402 in the entities 406 or a topic. Similarly, the user 402 may be connected to the related users 404 with a “related” edge 418 that describes the user 402 who is related to the related users 404 based on a common attribute. The “related” edge 418 may include a type of an edge that may be inferred to indicate that an entity may be relevant to the user 402.

The user 402 may also be connected to the related tags 408 which are promoted to topics based on the relationships. The user 402 may be connected to the related tags 408 with a “relatedtags” edge 416 defining the relationship. The related tags 408 may be connected to the document 410 with a “taggeddoc” edge 420 that defines the relationship between the topic that tags the document 410. The related users 404 may be connected to the documents 412 with a “taggedby” edge 422 that defines the relationship between the related users 404 who tag the documents 412.

The document 410 may be ranked within a list of documents. The list of documents transmitted to the user 402 in response to a query by the user 402 to retrieve the documents. The list of documents may include documents ranked based on a preference of the user 402 such as a frequency of use, a number of related topics, among others. A top subset of the list may also be transmitted to the user 402. The top subset may be selected based on a preference of the user 402 or based on an attribute of the documents matching or exceeding a threshold. In an another scenario, the list of documents may be generated based on a query associated with one or more topics. The list of documents may be transmitted to the user 402.

Topics associated with the document 410 may also be ranked within a list. The topics may be ranked based on a preference of the user 402 such as a frequency of use, a number of related documents, among others. The list of topics may be transmitted to the user 402 based on a query associated with the document 410. Alternatively, a subset of the ranked list of topics may be selected for a transmission to the user 402 or for another purpose. The subset may be determined based on an attribute of the topics in the subset matching or exceeding a threshold.

The document 410 may also be ranked within a list of documents by utilizing related topics in a proactive query to rank the documents. The proactive query may be predicted based on an interaction of the user 402 with the document management application. The interaction may include an initiation of a client interface associated with the document management application. The list that includes the document 410 may be ranked based on topics associated with the user 402 or other relationships associated with the user 402 such as documents recently accessed by the user, among others. The ranked list of documents may be made available in a home feed waiting for a query or an access event by the user 402.

The technical effect of ranking documents with topics within a graph may be enhancements in access to a document using relationships with other entities compared to solutions that lack indexed documents or provide simple indexing.

The example scenarios and schemas in FIG. 1 through 4 are shown with specific components, data types, and configurations. Embodiments are not limited to systems according to these example configurations. Ranking documents with topics within a graph may be implemented in configurations employing fewer or additional components in applications and user interfaces. Furthermore, the example schema and components shown in FIG. 1 through 4 and their subcomponents may be implemented in a similar manner with other values using the principles described herein.

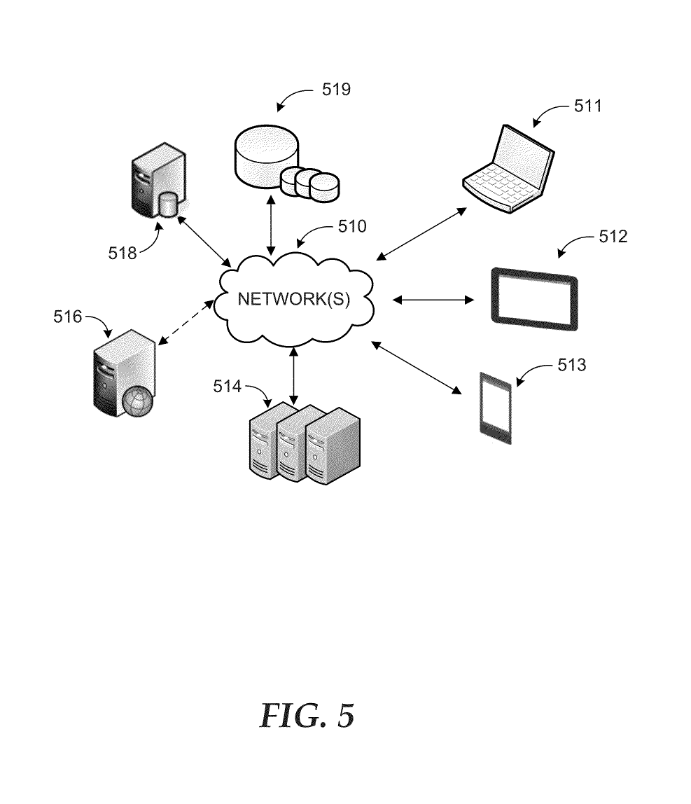

FIG. 5 is an example networked environment, where embodiments may be implemented. A document management application configured to rank documents with topics within a graph may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. A document management application may establish relationships between a user, a tag, and a document which may be nodes in a graph. The relationships may be established through edges that connect the nodes in the graph. The edges may be used to retrieve the documents. The document management application may store data associated with the tag and the document in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to rank documents with topics within a graph. Furthermore, the networked environments discussed in FIG. 5 are for illustration purposes only. Embodiments are not limited to the example applications, modules, or processes.

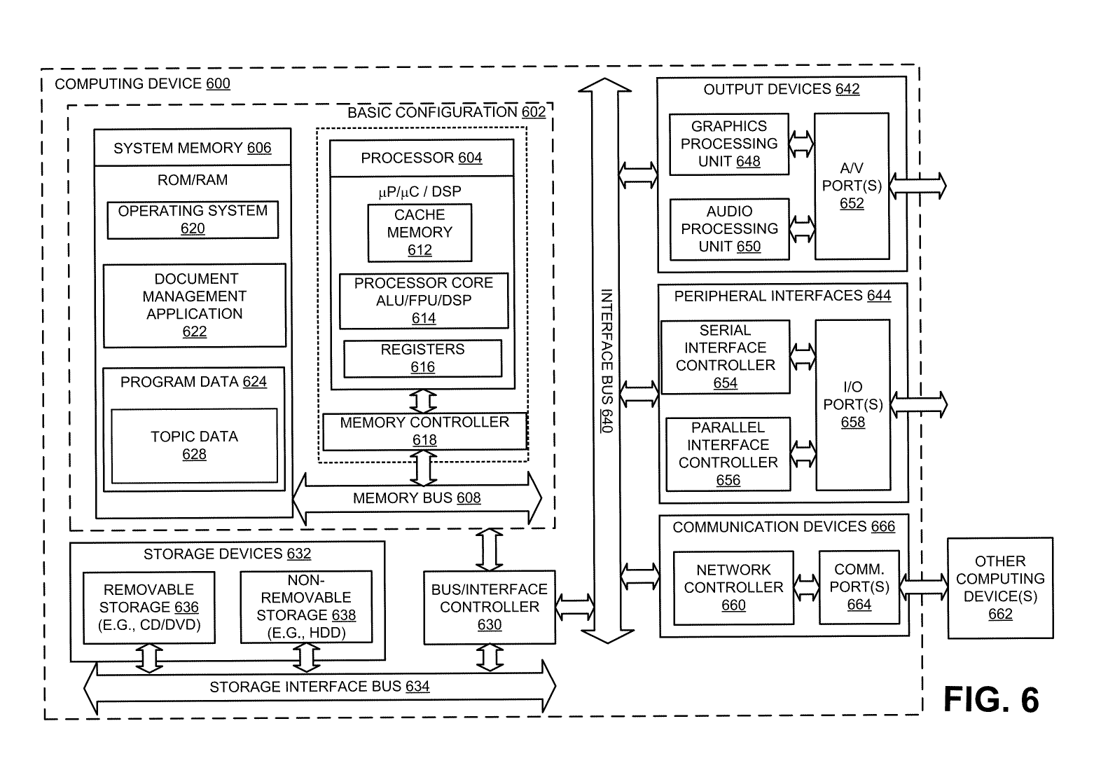

FIG. 6 illustrates a general purpose computing device, which may be configured to rank documents with topics in a graph, arranged in accordance with at least some embodiments described herein.

For example, the computing device 600 may be used to rank documents with topics in a graph. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604. The processor 604 may include a document management processor. The document management processor may include hardware components optimized to execute instructions of a document management application 622. The hardware components may execute the instructions an order of magnitude faster compared to a general purpose processor.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, the document management application 622, and a program data 624. The document management application 622 may establish relationships between a user, a tag, and a document which may be nodes in a graph. The tag may be promoted to a topic based on the relationships. Relationships may be described through edges connecting the nodes. The program data 624 may include, among other data, an topic data 628, or the like, as described herein. The topic data 628 may include the tag and one or more relationships.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include ranking of documents with topics in a graph. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

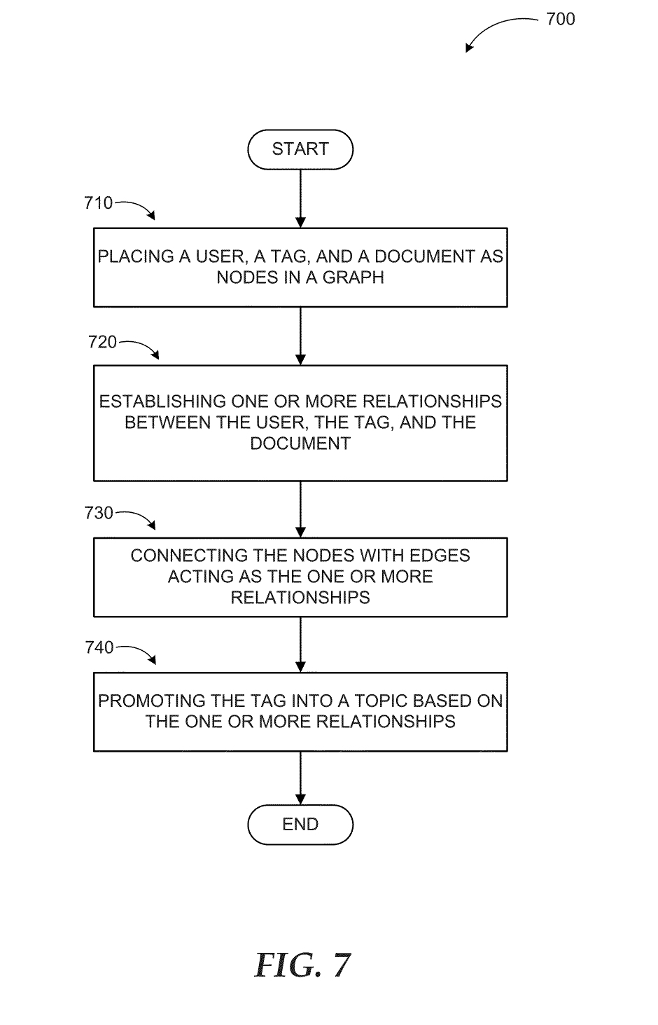

FIG. 7 illustrates a logic flow diagram for a process to rank documents with topics in a graph, according to embodiments. Process 700 may be implemented on a document management application.

Process 700 begins with operation 710, where a user, a tag, and a document may be placed as nodes in a graph. One or more relationships may be established between the user, the tag, and the document at operation 720. At operation 730, the nodes may be connected with edges acting as the one or more relationships. The tag may be promoted into a topic based on the one or more relationships at operation 740.

The operations included in process 700 are for illustration purposes. A document management application according to embodiments may be implemented by similar processes with fewer or additional steps, as well as in different order of operations using the principles described herein.

According to some examples, a method that is executed on a computing device to rank document with topics within a graph may be described. The method may include placing a user, a tag, and a document as nodes in a graph, establishing one or more relationships between the user, the tag, and the document, connecting the nodes with edges acting as the one or more relationships, and promoting the tag into a topic based on the one or more relationships associated with the tag.

According to other examples, the method may further include establishing a first relationship between the tag and the document with a “taggeddoc” edge, where the “taggeddoc” edge describes the tag used to tag the document, establishing a second relationship between the tag and the document with a “taggedwith” edge, where the “taggedwith” edge describes the document tagged with the tag, and including the first relationship and the second relationship in the one or more relationships associated with the topic.

According to further examples, the method may further include establishing a first relationship between the user and the tag with a first “follows” edge, where the first “follows” edge describes the user who follows the tag, establishing a second relationship between the user and another user with a second “follows” edge, where the second “follows” edge describes the user who follows the other user, and including the first relationship and the second relationship in the one or more relationships associated with the topic.

According to some examples, the method may further include establishing a first relationship between the user and the document with a “taggedby” edge, where the “taggedby” edge describes the document that is tagged by the user, establishing a second relationship between the user and the document with a “tagged” edge, where the “tagged” edge describes the user who tagged the document, and including the first relationship and the second relationship in the one or more relationships associated with the topic.

According to other examples, the method may further include establishing a first relationship between the user and the tag with a “relatedtags” edge, where the “relatedtags” edge describes the tag that is related to the user and including the first relationship in the one or more relationships associated with the topic. The first relationship may be detected based on one or more from a set of: a recentness and a number of interactions between the user and the tag. The first relationship may be detected based on one or more from a set of: a recentness and a number of interactions between the tag and a circle of the user, where the circle includes another user who is followed by the user.

According to further examples, the method may further include in response to a query associated with the document, the topic and other topics associated with the document may be retrieved, where the topic and the other topics include one or more from a set of: other tags associated with the document, a circle followed by the user who tagged the document, popular tags associated with the document, popular tags associated with the user, popular tags associated with the circle, recently applied tags, tags applied to the document by the user, and tags applied to the document by the circle and providing the topic and the other topics. In response to one from a set of a query associated with the topic and an event that accesses the topic, the document and other documents associated with the topic may be retrieved and the document and the other documents ordered in a tag feed may be provided, where the document and the other documents are ordered in the tag feed based on one or more factors from a set of: a recentness of tagging the document and the other documents with the topic, one or more edits of the document and the other documents by the user and a circle followed by the user, a popularity and a recentness of the document and the other documents by the circle. One or more tag suggestions associated with the document may be provided as additional topics, where the one or more tag suggestions are detected based on one or more from a set of: a tagging history of the user, a circle followed by the user that includes other users, and popular tags associated with the document. In response to a query associated with the topic that includes a partial entry for a name of the topic, one or more tags associated with the document may be retrieved, the partial entry may be matched to names of a subset of the one or more tags and the subset may be provided as potential topics for the document.

According to some examples, a computing device to rank documents with topics within a graph may be described. The computing device may include a memory, a processor coupled to the memory. The processor may be configured to execute a document management application in conjunction with instructions stored in the memory. The document management application may be configured to place a user, a tag, a document, and an entity as nodes in a graph, where the entity includes another user, establish one or more relationships between the user, the tag, the document, and the entity, connect the nodes with edges acting as the one or more relationships, and promote the tag into a topic based on the one or more relationships.

According to other examples, the document management application is further configured to detect an interest in the topic from an external input and determine one or more related topics. One or more updates on the topic may be retrieved based on one or more from a set of: a recentness and a volume of interactions with the topic and the topic, the one or more updates, and the one or more related topics may be provided.

According to further examples, the document management application is further configured to receive a query to retrieve the tag from an external input, match the query to names in a list that includes the tag and other tags based on a prefix that includes one or more attributes from a set of: a matched keyword, a recentness of use, a circle followed by the user that includes other users, and a popularity of the tag and the other tags, retrieve the tag and the other tags based on the matched names, and provide the tag and the other tags.

According to some examples, a computer-readable memory device with instructions stored thereon to rank documents with topics within a graph may be described. The instructions may include actions that are similar to the method described above.

According to some examples, a method that is executed on a computing device to rank document with topics within a graph may be described. The method may include a means for placing a user, a tag, and a document as nodes in a graph, a means for establishing one or more relationships between the user, the tag, and the document, a means for connecting the nodes with edges acting as the one or more relationships, and a means for promoting the tag into a topic based on the one or more relationships associated with the tag.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to rank documents with topics within a graph, the method comprising:
placing a user, a tag, and a document as nodes in a graph;
establishing one or more relationships between the user, the tag, and the document;
connecting the nodes with edges acting as the one or more relationships; and
promoting the tag into a topic based on the one or more relationships associated with the tag.

2. The method of claim 1, further comprising:
establishing a first relationship between the tag and the document with a “taggeddoc” edge, wherein the “taggeddoc” edge describes the tag used to tag the document;
establishing a second relationship between the tag and the document with a “taggedwith” edge, wherein the “taggedwith” edge describes the document tagged with the tag; and
including the first relationship and the second relationship in the one or more relationships associated with the topic.

3. The method of claim 1, further comprising:
establishing a first relationship between the user and the tag with a first “follows” edge, wherein the first “follows” edge describes the user who follows the tag;
establishing a second relationship between the user and another user with a second “follows” edge, wherein the second “follows” edge describes the user who follows the other user; and
including the first relationship and the second relationship in the one or more relationships associated with the topic.

4. The method of claim 1, further comprising:
establishing a first relationship between the user and the document with a “taggedby” edge, wherein the “taggedby” edge describes the document that is tagged by the user;
establishing a second relationship between the user and the document with a “tagged” edge, wherein the “tagged” edge describes the user who tagged the document; and
including the first relationship and the second relationship in the one or more relationships associated with the topic.

5. The method of claim 1, further comprising:
establishing a first relationship between the user and the tag with a “relatedtags” edge, wherein the “relatedtags” edge describes the tag that is related to the user; and
including the first relationship in the one or more relationships associated with the topic.

6. The method of claim 5, further comprising:
detecting the first relationship based on one or more from a set of: a recentness and a number of interactions between the user and the tag.

7. The method of claim 5, further comprising:
detecting the first relationship based on one or more from a set of: a recentness and a number of interactions between the tag and a circle of the user, wherein the circle includes another user who is followed by the user.

8. The method of claim 1, further comprising:
in response to a query associated with the document:
retrieving the topic and other topics associated with the document, wherein the topic and the other topics include one or more from a set of: other tags associated with the document, a circle followed by the user who tagged the document, popular tags associated with the document, popular tags associated with the user, popular tags associated with the circle, recently applied tags, tags applied to the document by the user, and tags applied to the document by the circle; and
providing the topic and the other topics.

9. The method of claim 1, further comprising:
in response to one from a set of a query associated with the document and an event that accesses the topic:
retrieving the document and other documents associated with the topic; and
providing the document and the other documents ordered in a tag feed, wherein the document and the other documents are ordered in the tag feed based on one or more factors from a set of: a recentness of tagging the document and the other documents with the topic, one or more edits of the document and the other documents by the user and a circle followed by the user, a popularity and a recentness of the document and the other documents by the circle.

10. The method of claim 1, further comprising:
providing one or more tag suggestions associated with the document as additional topics, wherein the one or more tag suggestions are detected based on one or more from a set of: a tagging history of the user, a circle followed by the user that includes other users, and popular tags associated with the document.

11. The method of claim 1, further comprising:
in response to a query associated with the topic that includes a partial entry for a name of the topic:
retrieving one or more tags associated with the document;
matching the partial entry to names of a subset of the one or more tags; and
providing the subset as potential topics for the document.

12. A computing device to rank documents with topics within a graph, the computing device comprising:
a memory;
a processor coupled to the memory, the processor executing a document management application in conjunction with instructions stored in the memory, wherein the document management application is configured to:
place a user, a tag, a document, and an entity as nodes in a graph, wherein the entity includes another user;
establish one or more relationships between the user, the tag, the document, and the entity;
connect the nodes with edges acting as the one or more relationships; and
promote the tag into a topic based on the one or more relationships.

13. The computing device of claim 12, wherein the document management application is further configured to:
detect an interest in the topic from an external input; and
determine one or more related topics.

14. The computing device of claim 12, wherein the document management application is further configured to:
retrieve one or more updates on the topic based on one or more from a set of: a recentness and a volume of interactions with the topic; and
provide the topic, the one or more updates, and the one or more related topics.

15. The computing device of claim 12, wherein the document management application is further configured to:
receive a query to retrieve the tag from an external input.

16. The computing device of claim 15, wherein the document management application is further configured to:
match the query to names in a list that includes the tag and other tags based on a prefix that includes one or more attributes from a set of: a matched keyword, a recentness of use, a circle followed by the user that includes other users, and a popularity of the tag and the other tags.

17. The computing device of claim 16, wherein the document management application is further configured to:
retrieve the tag and the other tags based on the matched names; and
provide the tag and the other tags.

18. A computer-readable memory device with instructions stored thereon to rank documents with topics within a graph, the instructions comprising:
placing a user, a tag, a document, and an entity as nodes in a graph, wherein the entity includes a circle of other users that is followed by the user;
establishing one or more relationships between the user, the tag, the document, and the entity;
connecting the nodes with edges acting as the one or more relationships; and
promoting the tag into a topic based on the one or more relationships.

19. The computer-readable memory device of claim 18, wherein the instructions further comprise:
establishing a relationship between the user and the document with a “taggedby” edge, wherein the “taggedby” edge describes the document that is tagged by the user; and
including the relationship in the one or more relationships associated with the topic.

20. The computer-readable memory device of claim 18, wherein the instructions further comprise:
receiving a query to retrieve the tag from an external input;
matching the query to names in a list that includes the tag and other tags based on a prefix that includes one or more attributes from a set of: a matched keyword, a recentness of use, the circle, and a popularity of the tag and the other tags;
retrieving the tag and the other tags based on the matched names; and
providing the tag and the other tags.
